(19) United States
(12) Patent Application Publication
(10) Pub. No.: US 2023/0281545 A1
(43) Pub. Date: Sep. 7, 2023

(54) INFORMATION PROCESSING DEVICE, INFORMATION PROCESSING METHOD, AND PROGRAM

(71) Applicant: Sony Group Corporation, Tokyo (JP)

(72) Inventors: Takao TAJIRI, Tokyo (JP); Takahiro ISHIKAWA, Saitama (JP); Masanori HASHIDO, Tokyo (JP); Takumi MORITA, Tokyo (JP)

(73) Assignee: Sony Group Corporation, Tokyo (JP)

(21) Appl. No.: 18/024,189

(22) PCT Filed: Aug. 23, 2021
(86) PCT No.: PCT/JP2021/030721

§ 371 Date: Mar. 1, 2023

(30) Foreign Application Priority Data
Sep. 8, 2020 (JP) 2020-150702
Dec. 14, 2020 (JP) 2020-207060

(51) Int. Cl. G06Q 10/0637; G06Q 40/06

(52) U.S. Cl. CPC G06Q 10/06375; G06Q 40/06

(57) ABSTRACT

An analysis that allows intuitively grasping a difference between an action of by analysis target person and an action by another task executor is achieved. There is provided an information processing device including an analysis unit that analyzes a tendency of a preference related to an action on the basis of action result data indicating a result of the action regarding a predetermined task, in which the analysis unit generates a similarity map representing a similarity between the actions by each of a plurality of task executors including an analysis target person on a two-dimensional plane on the basis of the action result data, and represents strength of a preference related to a type of the action selected in a heat map form in the similarity map.

### TECHNICAL FIELD

The present disclosure relates to an information processing device, an information processing method, and a program.

### BACKGROUND ART

It is quite important to appropriately analyze actions by task executors who execute certain tasks. For this reason, in recent years, many mechanisms for automating or assisting the analysis as described above have been proposed. For example, Patent Document 1 proposes a mechanism for analyzing investment action by an investment fund and performing rating based on a result of the analysis.

### CITATION LIST

### Patent Document

Patent Document 1: Japanese Patent Application Laid-Open No. 2009-245368

### SUMMARY OF THE INVENTION

### Problems to be Solved by the Invention

Furthermore, in a case where the analysis as described above is achieved with high accuracy, there is a case where an executed task or a task that can be executed by a third party can be reproduced using the result of the analysis.

### Solutions to Problems

According to an aspect of the present disclosure, there is provided an information processing device including an analysis unit that generates a similarity map representing a similarity between actions by each of a plurality of task executors on a two-dimensional plane on the basis of action result data indicating a result of the action regarding a predetermined task, in which the analysis unit outputs action reproduction data having a same data structure as the action result data on the basis of coordinate data representing a position of a plot in the similarity map.

Furthermore, according to another aspect of the present disclosure, there is provided an information processing method including: generating, by a processor, a similarity map representing a similarity between actions by each of a plurality of task executors on a two-dimensional plane on the basis of action result data indicating a result of the action regarding a predetermined task; and outputting action reproduction data having a same data structure as the action result data on the basis of coordinate data representing a position of a plot in the similarity map.

Furthermore, according to another aspect of the present disclosure, there is provided a program for causing a computer to function as an information processing device including an analysis unit that generates a similarity map representing a similarity between actions by each of a plurality of task executors on a two-dimensional plane on the basis of action result data indicating a result of the action regarding a predetermined task, in which the analysis unit outputs action reproduction data having a same data structure as the action result data on the basis of coordinate data representing a position of a plot in the similarity map.

### BRIEF DESCRIPTION OF DRAWINGS

FIG. 1 is a diagram illustrating an example of a similarity map according to a first embodiment of the present disclosure.

FIG. 2 is a diagram illustrating an example of the similarity map representing strength of preferences according to the same embodiment in a heat map form.

FIG. 3 is a block diagram illustrating a functional configuration example of a learning device 10 according to the same embodiment.

FIG. 4 is a block diagram illustrating a functional configuration example of an analysis device 20 according to the same embodiment.

FIG. 5 is a diagram for describing analysis by an analysis unit 210 according to the same embodiment.

FIG. 6 is a diagram for describing an example of action result data RD according to the same embodiment.

FIG. 7 is a diagram for describing an example of the action result data RD according to the same embodiment.

FIG. 8 is a diagram illustrating an example in which a degree of contribution calculated by SHAP 216 according to the same embodiment is visually represented.

FIG. 9 is a diagram illustrating an example in which the degree of contribution calculated by the SHAP 216 according to the same embodiment is visually represented.

FIG. 10 is a diagram for describing automatic selection of a type of action based on a degree of contribution according to the same embodiment.

FIG. 11 is a diagram for describing automatic selection of a type of action based on feedback by a user according to the same embodiment.

FIG. 12 is a diagram illustrating an example of a user interface UI1 that presents a result of analysis by the analysis unit 210 according to the same embodiment.

FIG. 13 is a diagram illustrating an example of the user interface UI1 that presents a result of analysis by the analysis unit 210 according to the same embodiment.

FIG. 14 is a diagram illustrating an example of the user interface UI1 that presents a result of analysis by the analysis unit 210 according to the same embodiment.

FIG. 15 is a diagram illustrating an example of the user interface UI1 that presents a result of analysis by the analysis unit 210 according to the same embodiment.

FIG. 16 is a diagram illustrating an example of the user interface UI1 that presents a result of analysis by the analysis unit 210 according to the same embodiment.

FIG. 17 is a flowchart illustrating an example of a flow of processing by the analysis device 20 according to the same embodiment.

FIG. 18 is a diagram for describing generation of action reproduction data according to a second embodiment of the present disclosure.

FIG. 19 is a diagram for describing generation of the action reproduction data according to the same embodiment.

FIG. 20 is a flowchart illustrating an example of a flow of action reproduction data generation according to the same embodiment.

FIG. 21 is a diagram for describing representation of the action reproduction data using existing action result data according to the same embodiment.

FIG. 22 is a flowchart illustrating one reason of a flow of action reproduction data output using the existing action result data according to the same embodiment.

FIG. 23 is a block diagram illustrating a hardware configuration example of an information processing device 90 according to one embodiment of the present disclosure.

### MODE FOR CARRYING OUT THE INVENTION

Hereinafter, preferred embodiments of the present disclosure will be described in detail with reference to the accompanying drawings. Note that in the present description and drawings, components which have substantially the same function configurations are given the same reference signs, thereby omitting duplicated descriptions.

Note that the description will be made in the following order.
1. First Embodiment
   1.1. Overview
   1.2. System configuration example
   1.3. Analysis details
   1.4. Example of user interface
   1.5. Flow of processing
2. Second Embodiment
   2.1. Generation of action reproduction data
   2.2. Representation of action reproduction data using existing action result data
3. Hardware configuration example
4. Summary

### 1. Embodiment

<<1.1. Overview>>

First, a first embodiment of the present disclosure will be described. As described above, it is quite important to appropriately analyze the action by a task executor who executes a predetermined task regardless of the industry type.

However, in a case where the expertise of the task executed by the task executor is high, and in a case where the analyst does not have the same level of expertise regarding the task as the task executor, it may be difficult to perform appropriate analysis.

Here, as an example, it is assumed a case where an action by an investment fund (hereinafter, simply referred to as a fund) is analyzed in a certain fund.

An analyst belonging to the fund assumes, for example, a contracted fund or a new fund that is a candidate for a future contract as an analysis target person, and analyzes an action by the analysis target person.

However, here, if the analyst belonging to the fund does not have the same level of expertise as the analysis target person, the analyst cannot grasp how the action by the analysis target person is different from that of other funds, and it is difficult to appropriately evaluate the analysis target person.

A technical idea according to the first embodiment of the present disclosure has been conceived by focusing on the above point, and achieves an analysis that allows intuitively grasping a difference between an action by the analysis target person and an action by another task executor.

For this purpose, an analysis device 20 according to the first embodiment of the present disclosure includes an analysis unit 210 that analyzes a tendency of a preference related to an action on the basis of action result data indicating a result of action regarding a predetermined task.

In addition, one of the characteristics of the analysis unit 210 according to the present embodiment is to generate, on the basis of the action result data, a similarity map representing a similarity of the above actions by each of a plurality of task executors including the analysis target person on a two-dimensional plane, and to represent strength of a preference related to the type of the selected action in a heat map form in the similarity map.

Note that, in the following, a case where the predetermined task is asset management and an action regarding the predetermined task described above is a trading transaction of a financial product will be described as a main example. In this case, the task executor including the analysis target person may be a fund.

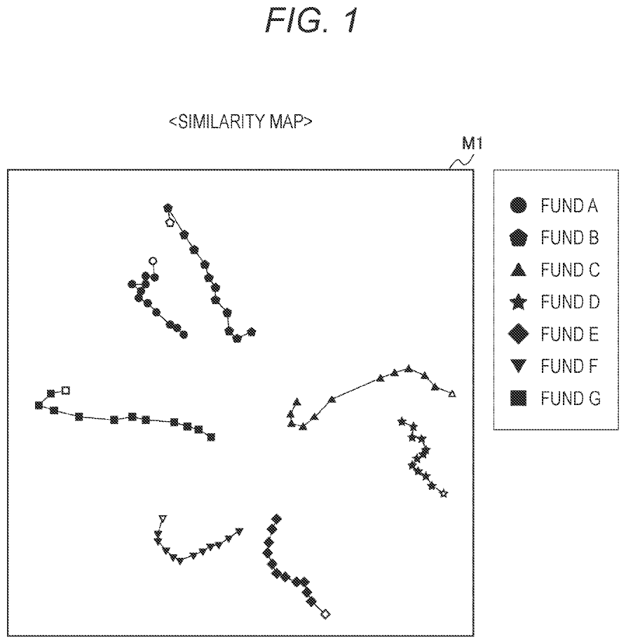

Here, the similarity map generated by the analysis unit 210 according to the present embodiment will be described with an example. FIG. 1 is a diagram illustrating an example of a similarity map according to the present embodiment.

For example, the analysis unit 210 according to the present embodiment can generate a similarity map M1 as illustrated in FIG. 1 on the basis of weight (active weight) information of a financial product that changes due to transaction action.

In the similarity map M1 illustrated in FIG. 1, characteristics of respective transaction actions by funds A to G are plotted using different symbols for each fund.

For example, in a case of the example illustrated in FIG. 1, a characteristic of a transaction action by the fund A is plotted using a round symbol, and a characteristic of a transaction action by the fund B is plotted using a pentagonal symbol.

Furthermore, in the similarity map according to the present embodiment, the similarity of the characteristics of respective transaction actions is represented as a distance on the map.

For example, in the example illustrated in FIG. 1, both the fund A and the fund B may be funds that take transaction actions focusing on a value strategy. In this case, respective plots indicating the characteristics of the transaction actions of the funds A and B may be arranged at a close distance in the similarity map M1.

Similarly, respective plots illustrating the characteristics of the transaction actions of the funds C and D focusing on a large growth strategy may be arranged at a close distance in the similarity map M1.

Similarly, respective plots illustrating the characteristics of the transaction actions of the funds E and F focusing on a small growth strategy may be arranged at a close distance in the similarity map M1.

As described above, with the similarity map generated by the analysis unit 210 according to the present embodiment, it is possible to visually represent a similarity related to characteristics of transaction actions of funds by using a distance.

With this configuration, the analyst who refers to the similarity map can intuitively grasp a fund having similar characteristics of transaction actions, or conversely a fund having dissimilar characteristics of transaction actions, and can use the fund for evaluation.

Furthermore, the analysis unit 210 according to the present embodiment may represent a change in action in time series by each of the plurality of task executors in the similarity map.

For example, each plot in the similarity map M1 illustrated in FIG. 1 indicates the characteristics of the transaction action of the corresponding fund in a certain month. As an example, the characteristic of the fund A in a certain month is described by a black circle or a white circle in the similarity map M1.

Note that, in the example illustrated in FIG. 1, a white circle may indicate the characteristic of the transaction action of the latest month of the fund A, and each black circle may indicate the characteristic of the transaction action of the past month of the fund A.

As described above, the analysis unit 210 according to the present embodiment may represent how the characteristics of the transaction action of the fund change in time series by connecting plots related to the same fund in time series by a line and distinguishing a plot related to the latest month from the past month.

With the representation as described above, it is possible to analyze how the characteristics of the transaction action of a certain fund change in time series.

For example, in the case of the example illustrated in FIG. 1, the sixth plot and the seventh plot from the most past of the fund C have a wide distance in the similarity map M1. In this case, the analyst can infer that there was a large change in the transaction action of the fund C between the month corresponding to the sixth plot and the month corresponding to the seventh plot described above.

In addition, with the time-series representation as illustrated in FIG. 1, it is also possible to analyze how the characteristics of the transaction actions between certain funds change in time series.

For example, in the case of the example illustrated in FIG. 1, the respective plots related to the funds A and B focusing on the value strategy are arranged at substantially close distances in time series. In this case, the analyst can infer that the fund A and the fund B have employed similar transaction strategies to a market change or the like in the past.

On the other hand, in the case of the example illustrated in FIG. 1, each plot related to the funds E and F focusing on the small growth strategy increases in distance with time. In this case, the analyst can infer that the fund E and the fund F have employed transaction strategies that are not similar to a market change or the like in the past.

The similarity map according to the present embodiment has been described above by way of example. With the similarity map as described above, it is possible to visually and intuitively perform analysis regarding similarity in transaction actions among the funds, temporal change of transaction action of a certain fund, and the like.

Furthermore, the analysis unit 210 according to the present embodiment may represent the strength of the preference related to the type of the selected action in the heat map form in the similarity map as described above.

Here, the type of action described above can be appropriately set according to a target task. For example, in a case where the task is asset management, the type of action according to the present embodiment includes holding of a financial product of a predetermined stock, holding of a financial product corresponding to a predetermined industry type, holding of a financial product corresponding to a predetermined factor, and the like.

That is, in a case of analyzing the transaction action of the fund, the analysis unit 210 according to the present embodiment may represent strength of a preference of the financial product corresponding to a predetermined stock, a predetermined industry type, and a predetermined factor by each fund in the heat map form in the similarity map.

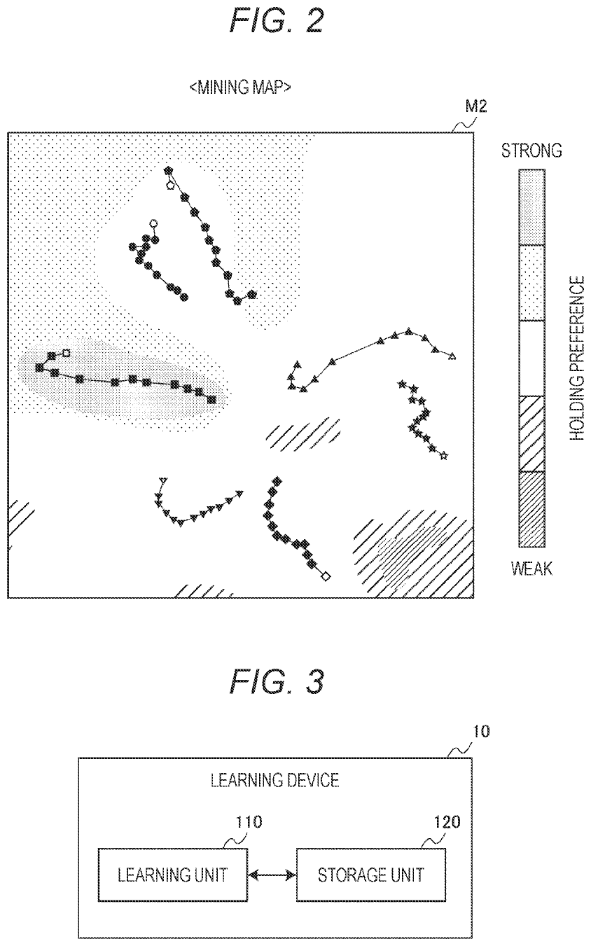

FIG. 2 is a diagram illustrating an example of the similarity map representing strength of preferences in the heat map form according to the present embodiment. FIG. 2 illustrates a similarity map M2 (hereinafter, also referred to as a mining map M2) representing strength of preferences regarding holding of financial products corresponding to mining in the heat map form.

Note that, in the example illustrated in FIG. 2, the strength of the preference regarding holding of financial products corresponding to mining is represented using dots and oblique lines.

Specifically, in a case of being represented by dots in the mining map M2, it is represented that a preference of holding financial products corresponding to mining is strong, and the higher the density of dots, the higher the degree of preference.

On the other hand, in a case of being represented by hatching in the mining map M2, it is represented that the preference of holding financial products corresponding to mining is low, and the higher the density of dots, the lower the degree of preference.

Furthermore, in the mining map M2 exemplified in FIG. 2, a plot related to each fund is described according to a rule similar to the legend illustrated in FIG. 1.

With reference to the mining map M2 based on these, it is possible to intuitively grasp that the funds A to F do not have a strong preference for holding financial products corresponding to mining, whereas the fund G has a very strong preference for holding financial products for mining.

As described above, with the analysis unit 210 according to the present embodiment, it is possible to represent a similarity in transaction actions among the funds by using a distance on the two-dimensional plane, and then represent the strength of a preference for holding a predetermined financial product in the heat map form.

Furthermore, with this configuration, it is possible to visually and intuitively grasp the difference in transaction actions among the funds by focusing on the preference related to holding of financial products.

The outline of the analysis by the analysis unit 210 according to the present embodiment has been described above. Note that, in the above description, the case where the predetermined task is the asset management and the action regarding the predetermined task is the trading transaction of a financial product has been described as an example.

However, the predetermined task and the action regarding the predetermined task according to the present embodiment are not limited to such examples.

For example, the predetermined task according to the present embodiment may be product sales expansion. Furthermore, the action regarding the predetermined task may include marketing.

In this case, the analysis unit 210 according to the present embodiment can perform analysis regarding similarity and preference of existing channels and newly employed channels on the basis of, for example, action result data regarding channels used for product sales and advertising. Results of such analysis are expected to be used for new employment of marketers, cancellation of contracts, optimization of marketing costs, and the like.

In addition, for example, the predetermined task according to the present embodiment may be acquisition of a contract. Furthermore, the action regarding the predetermined task may include various sales activities.

In this case, the analysis unit 210 according to the present embodiment can perform analysis regarding similarity and preference of various business activities (for example, visit, telephone, e-mail, presentation, and the like) on the basis of, for example, action result data regarding business activities. Results of such analysis are expected to be used for evaluation of similarity between an existing employee and a candidate for employment, evaluation of similarity between a transfer candidate human resource and a human resource at a transfer destination, and the like. As described above, the analysis method according to the present embodiment can also be applied to personnel evaluation in a company or the like.

Hereinafter, a system configuration example for achieving the analysis as described above will be described in detail.

<<1.2. System Configuration Example>>

A system according to the present embodiment includes a learning device 10 that performs learning using a machine learning algorithm and the analysis device 20 that performs analysis using an encoder and a decoder generated by learning by the learning device 10.

(Learning Device 10)

First, a functional configuration example of the learning device 10 according to the present embodiment will be described. FIG. 3 is a block diagram illustrating a functional configuration example of the learning device 10 according to the present embodiment.

As illustrated in FIG. 3, the learning device 10 according to the present embodiment may include a learning unit 110 and a storage unit 120.

(Learning Unit 110)

The learning unit 110 according to the present embodiment performs learning using a machine learning algorithm.

For example, the learning unit 110 according to the present embodiment performs learning related to a variational auto-encoder (VAE). The variational auto-encoder is a neural network-based generation model that performs learning using an auto-encoding variational Bayesian algorithm.

Specifically, the learning unit 110 according to the present embodiment performs learning to input the action result data to a neural network (encoder) and generate the similarity map.

Furthermore, the learning unit 110 according to the present embodiment inputs a latent variable at an arbitrary point on the similarity map to a neural network (decoder), and performs learning to reproduce the action result data.

The function of the learning unit 110 according to the present embodiment is achieved by a processor such as a GPU.

(Storage Unit 120)

The storage unit 120 according to the present embodiment stores various types of information regarding learning executed by the learning unit 110. For example, the storage unit 120 stores a structure of a network used for learning by the learning unit 110, various parameters related to the network, learning data, and the like.

The functional configuration example of the learning device 10 according to the present embodiment has been described above. Note that the functional configuration described above with reference to FIG. 3 is merely an example, and the functional configuration of the learning device 10 according to the present embodiment is not limited to such an example.

For example, the learning device 10 according to the present embodiment may further include an operation unit that receives an operation by the user, a display unit that displays various types of information, and the like.

The functional configuration of the learning device 10 according to the present embodiment can be flexibly modified according to specifications and management.

(Analysis Device 20)

Next, a functional configuration example of the analysis device 20 according to the present embodiment will be described. The analysis device 20 according to the present embodiment is an example of an information processing device that analyzes a tendency of a preference related to an action on the basis of the action result data.

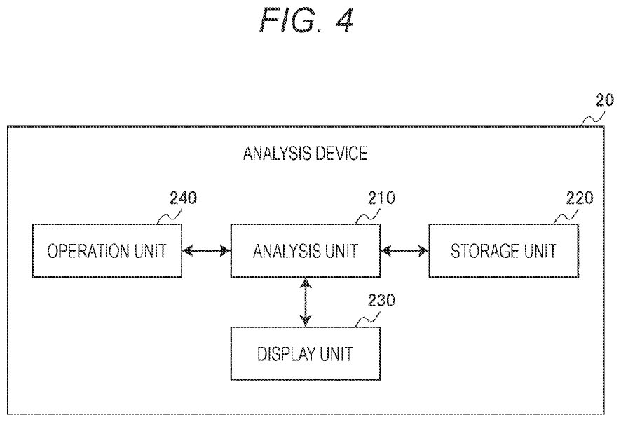

FIG. 4 is a block diagram illustrating a functional configuration example of the analysis device 20 according to the present embodiment. As illustrated in FIG. 4, the analysis device 20 according to the present embodiment may include the analysis unit 210, a storage unit 220, a display unit 230, and an operation unit 240.

(Analysis Unit 210)

The analysis unit 210 according to the present embodiment analyzes a tendency of a preference related to an action on the basis of the action result data indicating a result of the action regarding a predetermined task.

At this time, one of the characteristics of the analysis unit 210 according to the present embodiment is to generate the similarity map representing a similarity between actions by each of the plurality of task executors including the analysis target person on the two-dimensional plane on the basis of the action result data, and to represent the strength of the preference related to the type of the selected action in the heat map form in the similarity map.

For example, the analysis unit 210 according to the present embodiment may generate the similarity map representing a similarity between at least an action by the analysis target person and an action by a designated comparison target person on a two-dimensional plane, and represent strength of a preference of the analysis target person and strength of a preference of the comparison target person relating to a selected type of action in the heat map form in the similarity map.

According to the analysis as described above, the analyst can visually and intuitively grasp the strength of the preference of the analysis target person and the strength of the preference of the comparison target person related to the selected type of action.

Details of the analysis by the analysis unit 210 according to the present embodiment will be separately described. Note that the function of the analysis unit 210 according to the present embodiment is achieved by a processor such as a GPU.

(Storage Unit 220)

The storage unit 220 according to the present embodiment stores various types of information used by the analysis device 20. The storage unit 220 stores, for example, the action result data, structures and parameters of an encoder and a decoder used by the analysis unit 210, analysis results, and the like.

(Display Unit 230)

The display unit 230 according to the present embodiment displays various types of visual information. For this purpose, the display unit 230 according to the present embodiment includes a display.

For example, the display unit 230 according to the present embodiment displays a result of the analysis by the analysis unit 210 according to the control by the analysis unit 210. The result of the analysis described above includes the similarity map and the like.

(Operation Unit 240)

The operation unit 240 according to the present embodiment receives an operation by a user. For this purpose, the operation unit 240 according to the present embodiment includes various input devices such as a keyboard and a mouse.

The functional configuration of the analysis device 20 according to the present embodiment has been described above. Note that the functional configuration described above with reference to FIG. 4 is merely an example, and the functional configuration of the analysis device 20 according to the present embodiment is not limited to such an example.

For example, the analysis unit 210 and the storage unit 220 according to the present embodiment, and the display unit 230 and the operation unit 240 may be provided in separate devices. For example, the analysis unit 210 and the storage unit 220 may be included in an information processing device arranged on a cloud, and the display unit 230 and the operation unit 240 may be included in an information processing device arranged locally.

The functional configuration of the analysis device 20 according to the present embodiment can be flexibly modified according to specifications and management.

<<1.3. Details of Analysis>>

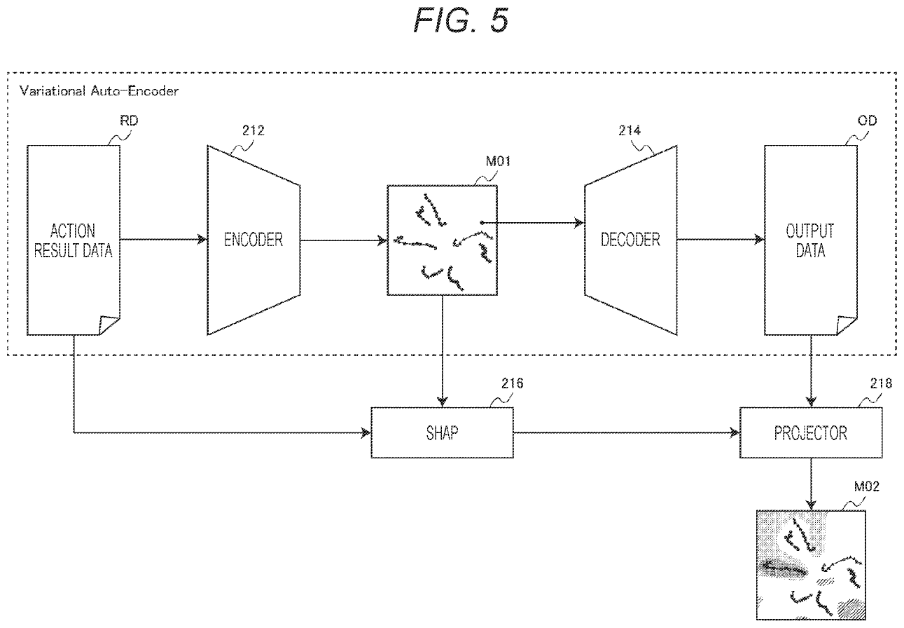

Next, the analysis by the analysis unit 210 according to the present embodiment will be described in detail. FIG. 5 is a diagram for describing analysis by the analysis unit 210 according to the present embodiment.

As illustrated, the analysis unit 210 according to the present embodiment first generates a similarity map M01 by inputting action result data RD to an encoder 212 generated by learning related to the variational auto-encoder by the learning device 10.

The content of the action result data RD according to the present embodiment can be designed according to a task to be analyzed. For example, in a case where the predetermined task is asset management, the action result data RD may include weight information related to a financial product for each fund.

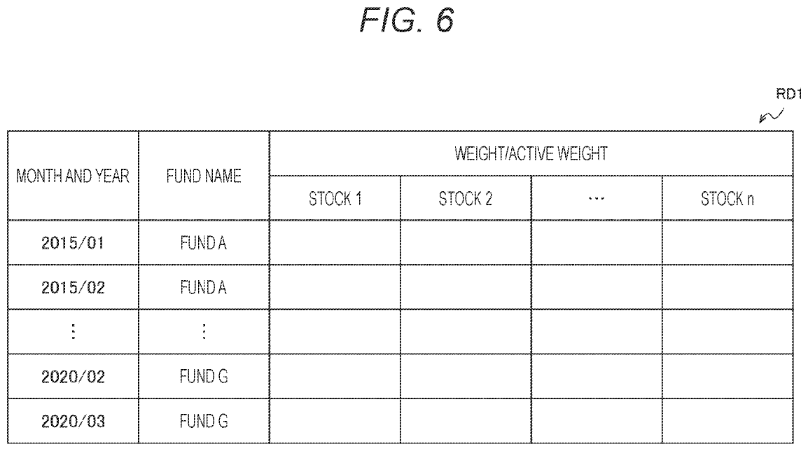

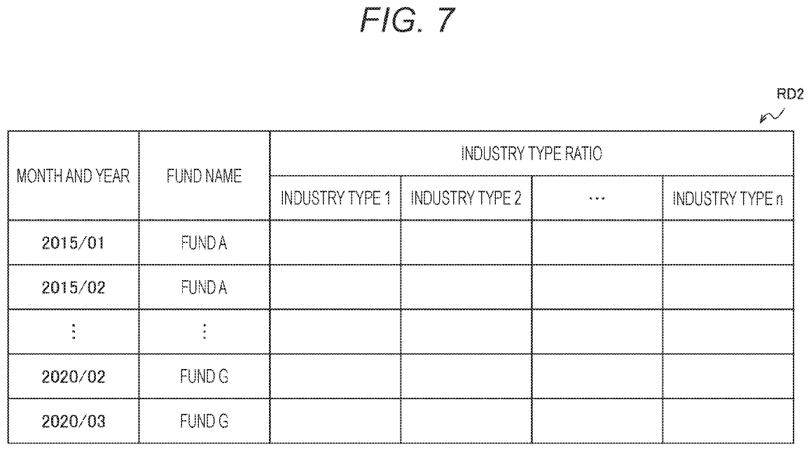

FIGS. 6 and 7 are diagrams for describing examples of the action result data RD according to the present embodiment.

For example, in a case of the example illustrated in FIG. 6, the action result data RD1 includes weight information or active weight information regarding a stock held by a certain fund in a certain month.

In a case where the weight information is employed, the action result data RD1 may include an absolute value of the holding amount for each stock.

On the other hand, in a case where the active weight information is employed, the action result data RD1 may include information regarding a difference between a holding amount of a stock held by the fund and a benchmark.

The action result data RD1 may include the weight information or the active weight information for each fund as described above for a period during which analysis is performed.

On the other hand, in a case of the example illustrated in FIG. 7, action result data RD2 includes information regarding a ratio of each industry type regarding a stock held by a certain fund in a certain month.

As described above, the action result data RD according to the present embodiment may not necessarily include information on the granularity of the stock. For example, even in a case where the action result data RD2 illustrated in FIG. 7 is used, it is possible to analyze preferences regarding predetermined industry types as illustrated in FIG. 2.

The information included in the action result data RD according to the present embodiment is only required to be selected according to the type of action by analyzing preferences.

In addition to the examples illustrated in FIGS. 6 and 7, examples of the information included in the action result data RD according to the present embodiment include the number of owned stocks, the number of newly added stocks, the number of all sold stocks, a trading turnover rate, a return, and the like.

The description will be continued again with reference to FIG. 5. After generating the similarity map M01, the analysis unit 210 according to the present embodiment inputs the latent variable at an arbitrary point on the similarity map M01 to a decoder 214 generated by learning related to the variational auto-encoder by the learning device 10, and obtains output data OD.

The output data OD output by the decoder 214 according to the present embodiment may be data obtained by reproducing the action result data input to the encoder 212.

For example, in a case where the action result data RD1 as illustrated in FIG. 6 is input to the encoder 212, the output data OD includes the weight information regarding each stock for each coordinate on the similarity map M01.

In addition, in a case where the action result data RD2 as illustrated in FIG. 7 is input to the encoder 212, the output data OD includes information regarding a ratio of each industry type for each coordinate on the similarity map M01.

That is, with the decoder 214 according to the present embodiment, it is possible to obtain the output data OD obtained by interpolating unknown data that is not included in the action result data RD.

Furthermore, the analysis unit 210 according to the present embodiment generates a similarity map M02 representing the strength of the preference related to the type of action in the heat map form on the basis of the output data OD as described above.

With this configuration, it is possible to achieve heat map representation over the entire map as in the similarity map M2 illustrated in FIG. 2.

Note that the analysis unit 210 according to the present embodiment may automatically select a type of action having a large difference in strength of preferences between the analysis target person and the comparison target person, and generate the similarity map M02 representing the strength of the preference related to the selected type of action in the heat map form.

A projector 218 included in the analysis unit 210 according to the present embodiment is configured to automatically select a type of action having a large difference in strength of preferences between the analysis target person and the comparison target person described above, and generate a heat map representation related to the type of action.

For example, the projector 218 according to the present embodiment may select the type of action having a difference in strength of preferences between the analysis target person and the comparison target person on the basis of a degree of contribution of each element included in the action result data RD to the generation of the similarity map M01.

The degree of contribution described above is calculated by SHapley Additive exPlanations (SHAP) 226 included in the analysis unit 210, for example.

SHAP is a model that calculates a value indicating how each element in the input data has affected the prediction value of the model in the learned model, that is, the degree of contribution of each data to the prediction value.

For example, the SHAP 216 according to the present embodiment calculates the degree of contribution (SHAP value) of each element included in the action result data RD to the generation of the similarity map M01 by the encoder 212.

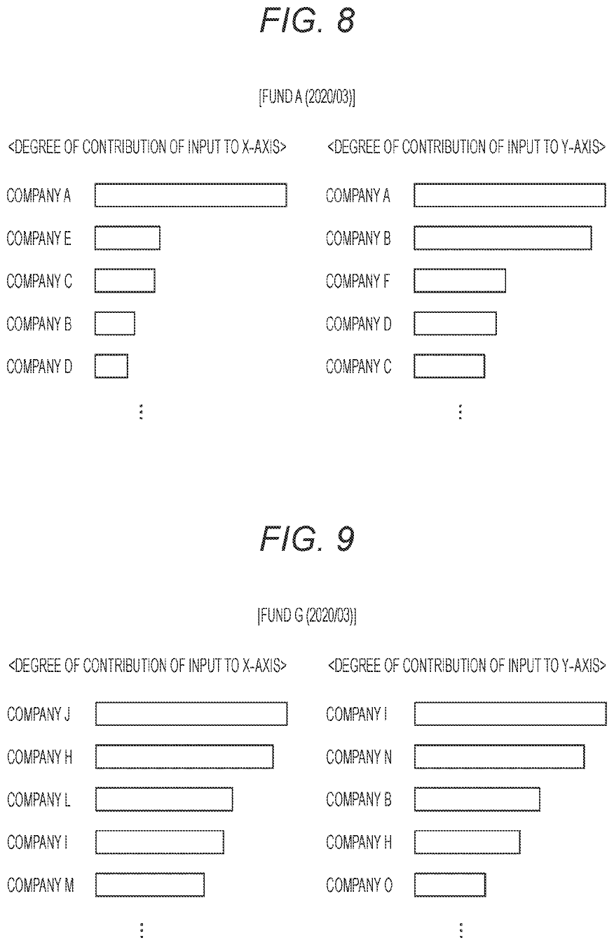

FIGS. 8 and 9 are diagrams illustrating an example in which the degree of contribution calculated by the SHAP 216 according to the present embodiment is visually represented.

For example, in the example illustrated in FIG. 8, in the action result data related to the fund A in March 2020, each element included in the action result data (in the example illustrated in FIG. 8, each stock) is illustrated in a ranking form in descending order of the degree of contribution to the X-axis or the Y-axis of the similarity map.

For example, in the example illustrated in FIG. 8, it can be grasped that the degree of contribution of the stock corresponding to the company A is the highest on both the X-axis and the Y-axis.

On the other hand, in the example illustrated in FIG. 9, in the action result data related to the fund G in March 2020, each element included in the action result data (in the example illustrated in FIG. 9, each stock) is illustrated in a ranking form in descending order of the degree of contribution to the X-axis or the Y-axis of the similarity map.

For example, in the example illustrated in FIG. 9, it can be grasped that the stock corresponding to the company J has the highest degree of contribution to the X-axis, and the stock corresponding to the company I has the highest degree of contribution to the Y-axis.

The projector 218 according to the present embodiment may automatically select the type of action to be represented in the heat map form on the basis of the degree of contribution calculated as described above.

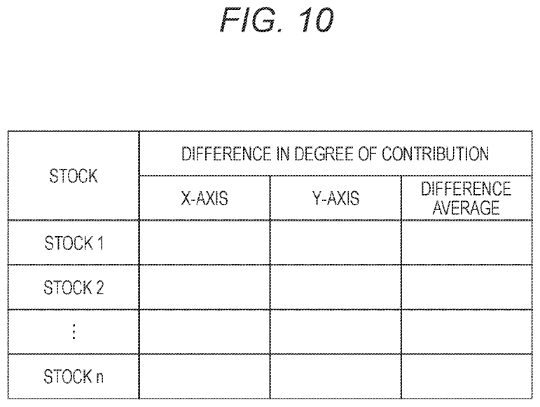

FIG. 10 is a diagram for describing automatic selection of the type of action based on the degree of contribution according to the present embodiment. For example, as illustrated in FIG. 10, the projector 218 according to the present embodiment may calculate a difference in the degree of contribution (SHAP value) for each stock between the analysis target person and the comparison target person.

For example, the projector 218 may calculate a difference in the degree of contribution for each stock between the analysis target person and the comparison target person on each of the X-axis and the Y-axis, and may further calculate an average of the difference on the X-axis and the difference on the Y-axis.

In this case, the projector 218 can determine that the higher the average of the difference on the X-axis and the difference on the Y-axis, the larger the difference in strength of preferences for the stocks.

For this reason, the projector 218 may select a stock having a high average of the difference on the X-axis and the difference on the Y-axis from the top, and generate the similarity map M02 representing the strength of preferences related to the stock, an industry type related to the stock, a factor related to the stock, and the like in the heat map form.

In addition, the projector 218 may perform clustering of stocks on the basis of the difference in the degree of contribution as illustrated in FIG. 10, specify a group having a large weighted average value of a difference average, and generate the similarity map M02 representing the strength of a preference related to the group in the heat map form.

Furthermore, the projector 218 according to the present embodiment may accumulate feedback of the user with respect to the similarity map represented in the heat map form, and automatically select a type of action to be represented in the heat map on the basis of the feedback.

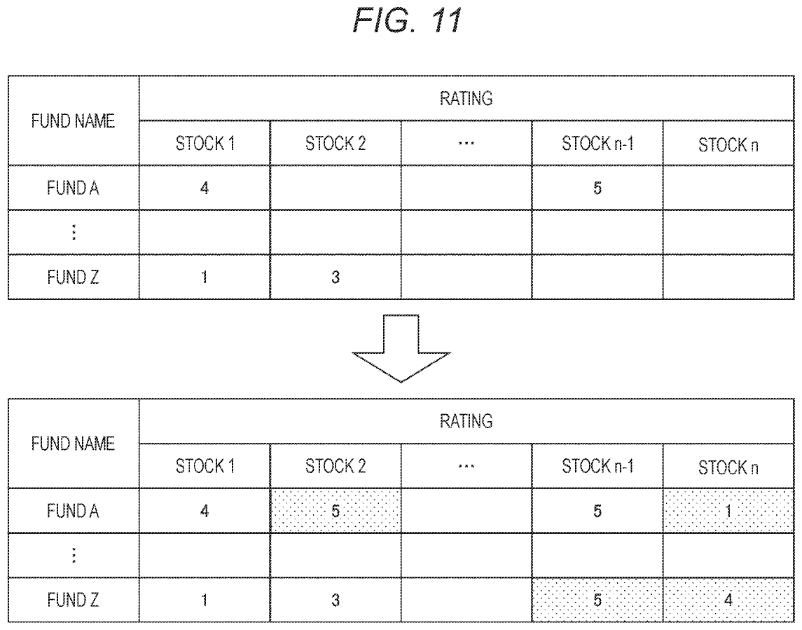

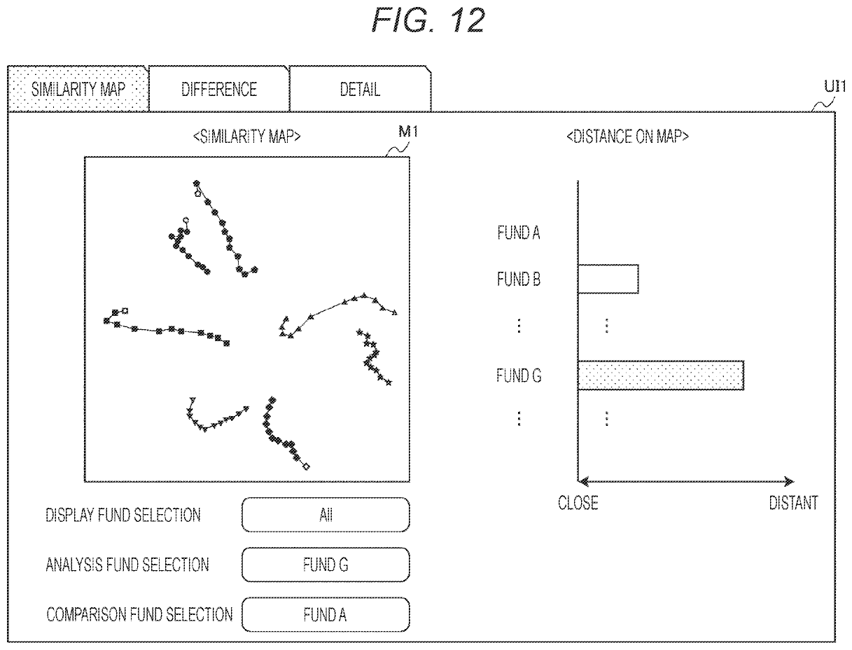

FIG. 11 is a diagram for describing automatic selection of a type of action based on feedback by the user according to the present embodiment.

For example, the user checks the similarity map representing the strength of the preference for each stock in the heat map form, and feeds back an evaluation value representing whether the preference of the corresponding stock is characteristic of the corresponding fund in five levels as illustrated in the upper part of FIG. 11.

Thereafter, as illustrated in the lower part of FIG. 11, the projector 218 performs matrix decomposition based on a value given as feedback by the user, and predicts an evaluation value of a stock for which feedback has not been performed. In FIG. 11, an evaluation value predicted by the projector 218 is emphasized by dots.

Next, the projector 218 automatically selects a stock on the basis of the evaluation value fed back by the user and the predicted evaluation value, and presents the similarity map representing the strength of the preference related to the selected stock in the heat map form to the user.

By repeatedly performing the presentation of the similarity map, or the like, the feedback of the evaluation value by the user, the prediction of the evaluation value based on the feedback, and so on as described above, the projector 218 can improve the accuracy of selecting a stock having a tendency of a preference that is characteristic to the fund.

<<1.4. Example of User Interface>>

The details of the analysis by the analysis unit 210 according to the present embodiment have been described above. Next, a user interface that presents a result of analysis by the analysis unit 210 according to the present embodiment will be described with an example.

FIGS. 12 to 16 are diagrams illustrating an example of a user interface UI1 that presents a result of analysis by the analysis unit 210 according to the present embodiment. The analysis unit 210 according to the present embodiment may control the user interface UI1 by the display unit 230.

Note that, in each of the similarity maps illustrated in FIGS. 12 to 16, a plot related to each fund is described according to a rule similar to the legend illustrated in FIG. 1.

FIG. 12 illustrates an example of a “similarity map” tab included in the user interface UI1.

In the “similarity map” tab, for example, the similarity map M1 generated by the analysis unit 210 may be displayed.

Furthermore, the user may be able to select a fund whose information is to be displayed on the similarity map M1, for example, using a field as illustrated in a lower left part of FIG. 12.

Furthermore, the user may be able to arbitrarily select a fund to be the analysis target person or a fund to be the comparison target comparison target person with the analysis target person using a field as illustrated in a lower left part of FIG. 12.

The setting of the analysis target person and the comparison target person as described above is particularly effective in a case where it is desired to compare the similarities in actions between certain specific funds.

For example, it is assumed a case where the user searches for a candidate fund for a new contract when the contract of a fund under contract expires. In this case, the user may set the fund under contract (for example, the fund A) as the comparison target person, and set the candidate fund (for example, the fund G) as the analysis target person.

With the setting as described above, it is possible to perform detailed analysis focusing on the similarity between an action by the fund under contract and an action by the candidate fund.

Furthermore, in this case, the analysis unit 210 may display information indicating a distance of each fund on the similarity map M1 based on the fund set as the comparison target person on the user interface UI1.

In a case of the example illustrated in FIG. 12, the analysis unit 210 displays the distance of each fund on the similarity map M1 based on the fund A set as the comparison target person, and highlights the distance related to the fund G set as the analysis target person.

With the display control as described above, it is possible to relatively grasp how far the analysis target person and the comparison target person are from each other in the similarity map M1 by comparison with other funds.

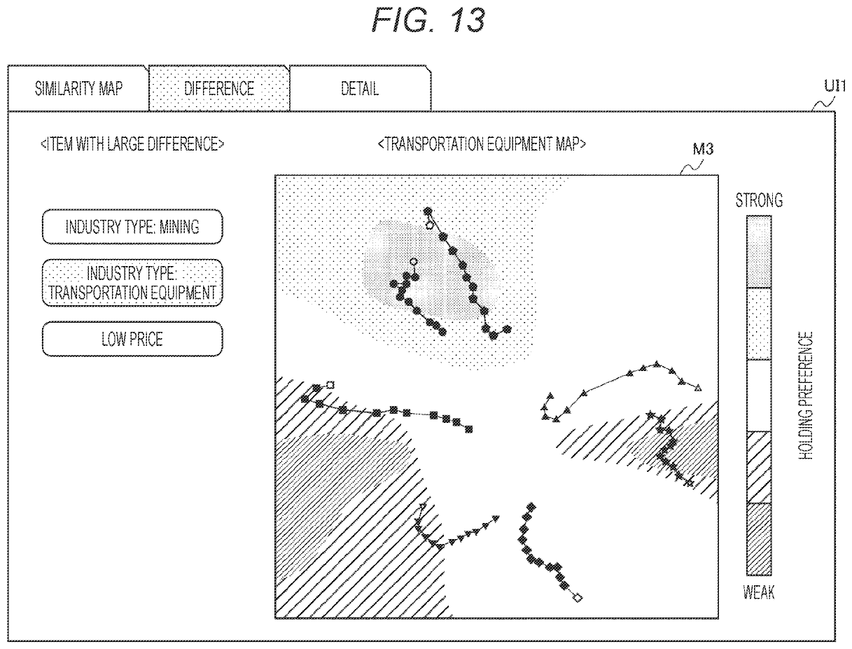

Furthermore, FIGS. 13 to 15 illustrate an example of a “difference” tab included in the user interface UI1. In the tab, the analysis unit 210 according to the present embodiment may present a plurality of types of action having a large difference in strength of preferences between the analysis target person and the comparison target person to the user.

Furthermore, in this case, the analysis unit 210 according to the present embodiment may display the similarity map representing the strength of a preference related to a type of action selected by the user in the heat map form.

For example, in a case of the example illustrated in FIGS. 13 to 15, the analysis unit 210 presents “industry type: mining”, “industry type: transportation equipment”, and “low price” as types of action having a large difference in strength of preferences between the fund G set as the analysis target person and the fund A set as the comparison target person.

The analysis unit 210 according to the present embodiment can automatically select the type of action as described above on the basis of the degree of contribution or the like calculated using the SHAP 216 described above.

Here, for example, as illustrated in FIG. 13, in a case where the user selects the “industry type: transportation equipment”, the analysis unit 210 may display, on the user interface UI1, a similarity map M3 (hereinafter, also referred to as a transportation equipment map M3) representing the strength of preferences regarding holding of financial products corresponding to the “industry type: transportation equipment” in the heat map form.

With the transportation equipment map M3 illustrated in FIG. 13, the user can visually and intuitively grasp that the fund A set as the comparison target person has a strong preference for holding financial products corresponding to the transportation equipment, whereas the fund G set as the analysis target person has a weak degree of preference for holding financial products for the transportation equipment.

Furthermore, with this configuration, the user can estimate that the holding amount of the financial products corresponding to the transportation equipment will greatly decrease in a case where the fund A is replaced with the fund G.

On the other hand, in a case where the user selects “industry type: mining”, the analysis unit 210 may display the mining map M2 as illustrated in FIG. 2 on the user interface UI1.

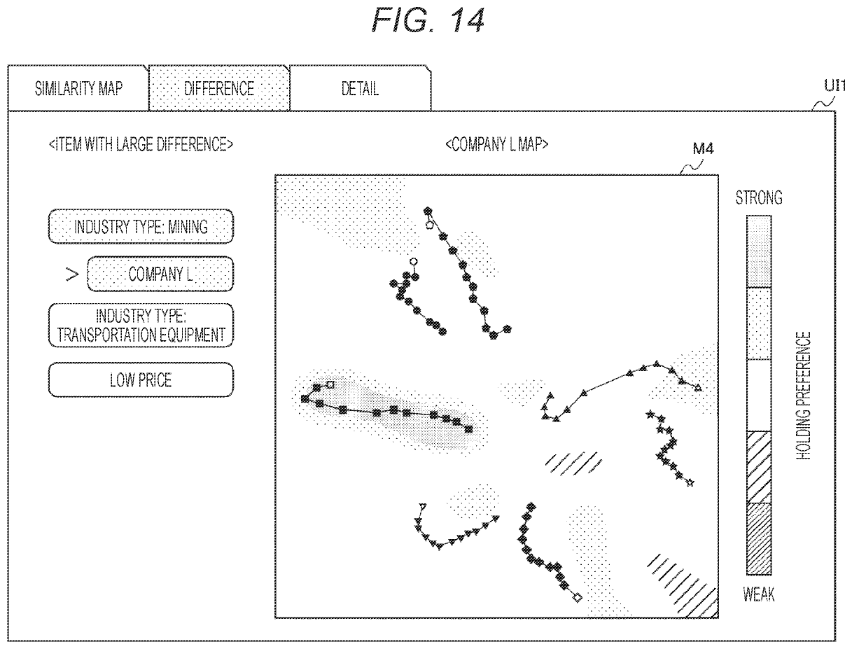

In addition, in this case, the analysis unit 210 may present individual stocks for which there is a particular difference in preferences for the “industry type: mining” as in “company L” illustrated in FIG. 14.

Here, in a case where the user selects the “company L”, the analysis unit 210 may display, on the user interface UI1, a similarity map M4 (hereinafter, also referred to as a company L map M4) representing the strength of a preference regarding holding of a financial product corresponding to the “company L” in the heat map form.

With the mining map M2 illustrated in FIG. 2 and the company L map M4 illustrated in FIG. 14, the user can visually and intuitively grasp that the fund A set as the comparison target person does not have a strong preference for holding financial products corresponding to mining, whereas the fund G set as the analysis target person has a strong preference for holding financial products corresponding to mining.

Furthermore, with this configuration, the user can infer that the holding amount of the financial products corresponding to mining will greatly increase in a case where the fund A is replaced with the fund G, and can consider whether or not the risk can be tolerated.

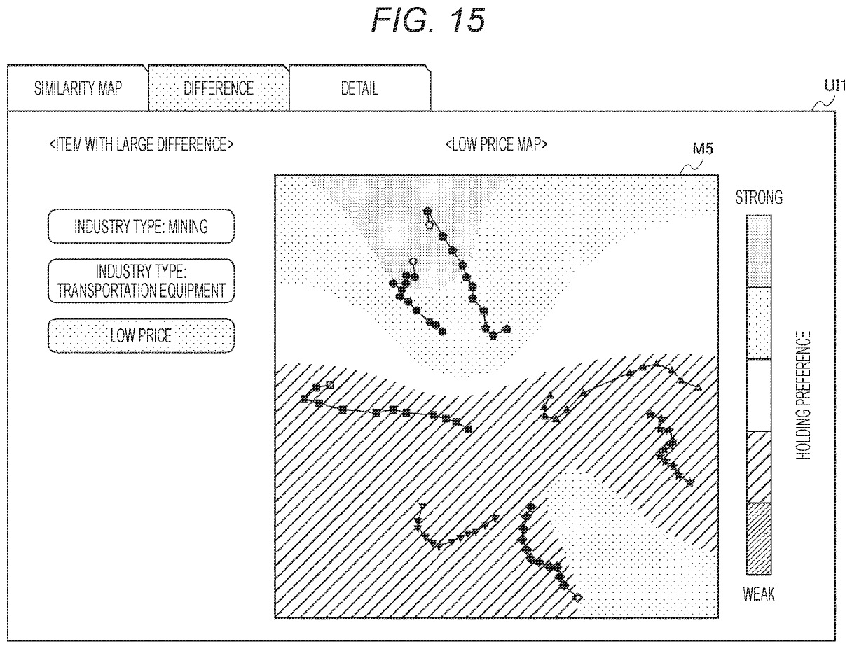

On the other hand, as illustrated in FIG. 15, in a case where the user selects “low price”, the analysis unit 210 may display a similarity map M5 (hereinafter, also referred to as a low price map M5) representing the strength of a preference regarding holding of financial products corresponding to the factor “low price” in the heat map form on the user interface UI1.

As described above, the analysis unit 210 according to the present embodiment can also represent the strength of a preference regarding holding of financial products corresponding to a predetermined factor in the heat map form on the similarity map.

With the low price map M5 illustrated in FIG. 15, the user can visually and intuitively grasp that the fund A set as the comparison target person has a strong preference for holding financial products corresponding to the factor “low price”, whereas the fund G set as the analysis target person has a weak degree of preference for holding financial products for the factor “low price”.

Furthermore, with this configuration, the user can estimate that the amount of financial products held corresponding to the factor “low price” will greatly decrease in a case where the fund A is replaced with the fund G.

An example of information presentation in the “difference” tab according to the present embodiment has been described above. With the information presentation illustrated in FIGS. 13 to 15, the user can visually and intuitively grasp the information related to the type of action having a large difference in preferences between the analysis target person and the comparison target person only by selecting the items automatically listed by the analysis unit 210.

On the other hand, in addition to the types of action listed by the analysis unit 210, the user may be able to cause the similarity map representing the degree of preference related to the type of action selected by the user himself/herself in the heat map form to be displayed on the user interface.

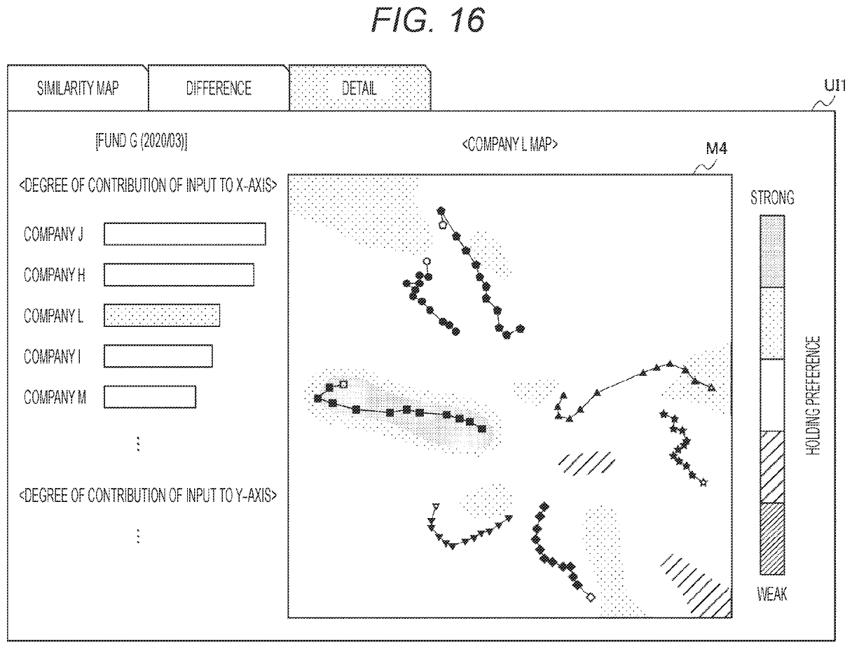

FIG. 16 illustrates an example of a “detail” tab included in the user interface UI1. For example, the analysis unit 210 according to the present embodiment may present, in the tab, a graph visually representing the degree of contribution related to each stock as illustrated in FIGS. 8 and 9.

In this case, the analysis unit 210 according to the present embodiment may represent the strength of the preference related to the type of action corresponding to the element selected by the user on the basis of the degree of contribution to be presented in the heat map form in the similarity map.

For example, in a case of the example illustrated in FIG. 16, the analysis unit 210 displays the company L map M4 on the user interface UI1 on the basis of the user selecting “company L” in the graph visually representing the degree of contribution related to each stock.

Note that, in addition to the company L map M4, the analysis unit 210 may further display the similarity map representing the strength of the preferences related to the industry type and the factor corresponding to the “company L” in the heat map form.

With the control as described above, the user can visually and intuitively grasp the difference in transaction actions among the funds by focusing on the preference related to holding of an arbitrary financial product.

<<1.5. Flow of Processing>>

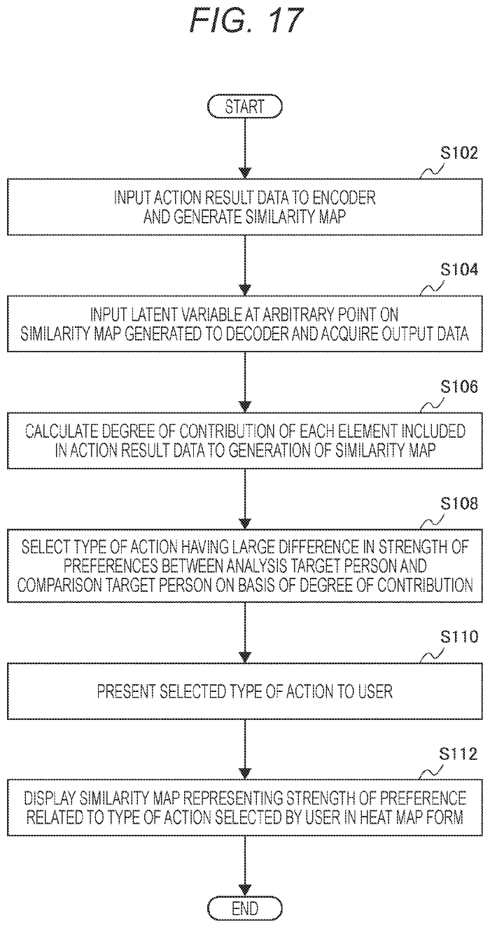

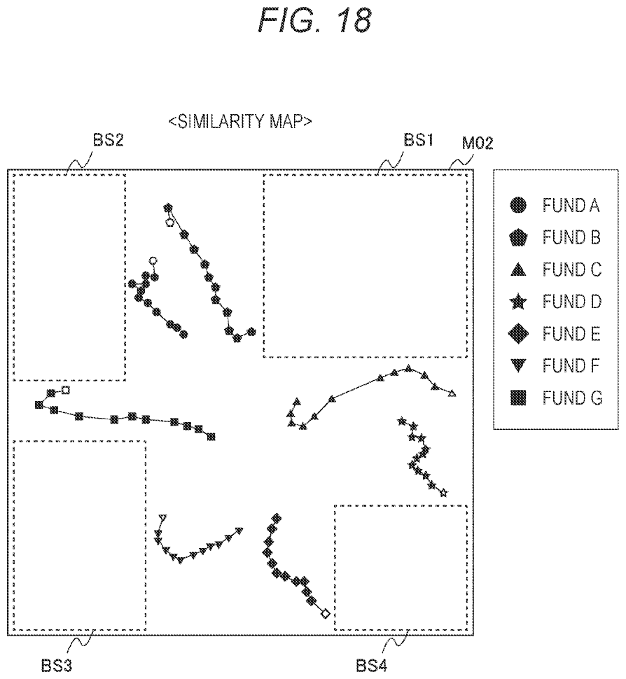

Next, a flow of processing by the analysis device 20 according to the present embodiment will be described in detail with an example. FIG. 17 is a flowchart illustrating an example of a flow of processing by the analysis device 20 according to the present embodiment.

In a case of the example illustrated in FIG. 17, first, the analysis unit 210 inputs the action result data to the encoder 212 and generates the similarity map (S102).

Next, the analysis unit 210 inputs the latent variable at an arbitrary point on the similarity map generated in step S102 to the decoder 214 and acquires output data (S104).

Furthermore, the analysis unit 210 calculates the degree of contribution of each element included in the action result data to the generation of the similarity map in step S102 using the SHAP 216 (S106).

Next, the analysis unit 210 selects a type of action having a large difference in strength of preferences between the analysis target person and the comparison target person on the basis of the degree of contribution or the like calculated in step S106 (S108).

Next, the analysis unit 210 presents the type of action selected in step S108 to the user via the user interface UI1 (S110).

Next, the analysis unit 210 displays, on the user interface UI1, the similarity map representing the strength of the preference related to the type of action selected by the user in the user interface UI1 in the heat map form (S112).

The flow of processing by the analysis device 20 according to the present embodiment has been described in detail with an example. Note that the flow of processing described above with reference to FIG. 17 is merely an example, and the flow of processing by the analysis device 20 according to the present embodiment is not limited to such an example.

The flow of processing by the analysis device 20 according to the present embodiment can be flexibly modified according to specifications and management.

### 2. Second Embodiment

<<2.1. Generation of Action Reproduction Data>>

Next, a second embodiment of the present disclosure will be described. Note that, in the following description, differences from the first embodiment will be focused on, and detailed description of configurations and effects common to the first embodiment will be omitted.

In the first embodiment described above, the case where the analysis device 20 analyzes the difference (similarity) between the action by the analysis target person and the action by another task executor using the similarity map has been described as a main example.

Meanwhile, use of the similarity map is not limited to the analysis as described above. For example, the analysis device 20 can reproduce an executed task or a task that can be executed by a third party using the similarity map.

In the following, as in the first embodiment, a case where the predetermined task is asset management and the action regarding the predetermined task is the trading transaction of a financial product will be described as a main example. Furthermore, the task executor is assumed to be a fund.

For example, in asset management, risk dispersion is a major problem. Since the market value of each asset fluctuates depending on the market environment, it can be said that an asset whose value is highly variable and whose profit can be expected is highly likely to suffer a loss on the other hand. For this reason, it is important to disperse the risk by combining assets that move differently depending on the market.

As an example, in a case where a new fund is contracted in a fund or the like, it is possible to achieve the distribution of the risk by employing a fund having different characteristics of managed assets and methods from those of the contracted fund.

However, with conventional general tools, in a case where the analyst does not have expertise, it has been difficult to intuitively grasp a difference in asset management among the funds, and thus it has been also difficult to find a new fund that performs asset management different from that of the contracted fund.

On the other hand, with the similarity map generated by the analysis device 20 according to one embodiment of the present disclosure, even in a case where the analyst does not have expertise, it is possible to intuitively grasp the difference in asset management among the funds.

Furthermore, the analysis device 20 according to the second embodiment of the present disclosure can output action reproduction data reproducing a task that can be executed by a third party having a characteristic different from that of the contracted fund by using the generated similarity map.

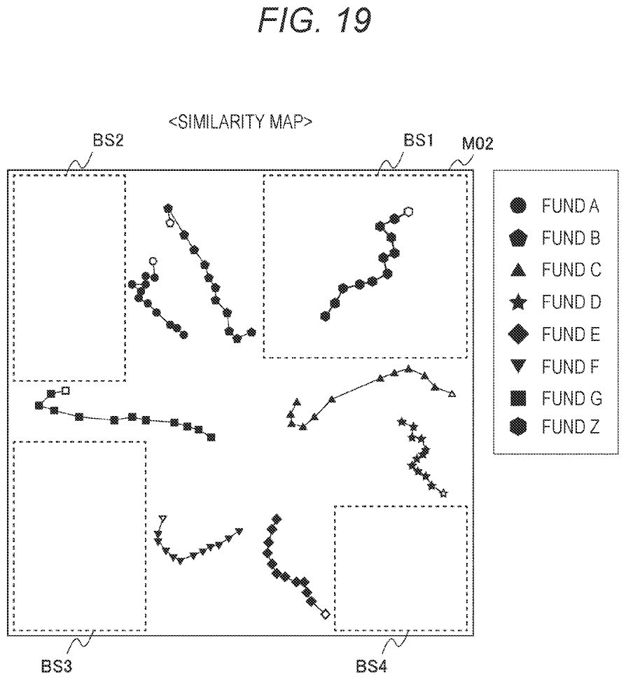

FIGS. 18 and 19 are diagrams for describing generation of the action reproduction data according to a second embodiment of the present disclosure.

FIG. 18 illustrates a similarity map M02 generated by the analysis unit 210. Similarly to the case of the first embodiment, each plot in the similarity map M02 represents a characteristic of asset management of a predetermined fund in a predetermined period. That is, the closer the distance between the plots, the more similar the characteristics of the asset management, and the farther the distance between the plots, the more different the characteristics of the asset management.

Here, in the similarity map M02 illustrated in FIG. 18, attention is paid to a region where the density of plots is low, particularly, a blank region BS1 to a blank region BS4 where there is no plot.

Since there is no plot based on the asset management by the funds A to G in the blank regions BS1 to BS4, it can be considered that the region is a region that is not covered by the asset management by an existing fund and is highly likely to include a portfolio of a new management method.

That is, in a case where the asset management corresponding to the plots located in the blank region BS1 to the blank region BS4 can be reproduced, data regarding the asset management having characteristics different from those of the existing fund can be obtained.

A technical idea according to the second embodiment of the present disclosure has been conceived focusing on the above points, and makes it possible to accurately reproduce a task corresponding to coordinates specified in the similarity map.

Accordingly, one of the characteristics of the analysis unit 210 of the analysis device 20 according to the present embodiment is to output the action reproduction data having the same data structure as the action result data on the basis of coordinate data indicating a position of a plot in the similarity map.

Furthermore, as described above, in a case where a change in action in time series by each of the plurality of task executors is represented in the similarity map, the analysis unit 210 may output the action reproduction data representing the change in time series on the basis of the coordinate data.

For example, in a case of the example illustrated in FIG. 19, in the blank region BS1 of the similarity map M02, a plot (hexagon) assuming characteristics of asset management by a fictitious fund Z is drawn in a time series equivalent to the action result data used for generating the similarity map M02.

Each plot related to the fund Z is sufficiently separated from each plot based on the action result data of the existing funds A to G used for generating the similarity map M02, and can be said to represent asset management having characteristics different from those of the existing funds A to G.

The analysis unit 210 according to the present embodiment can output the action reproduction data having the same data structure as the action result data by inputting coordinate data (x_{z}, y_{z}) indicating the position of each plot related to the fund Z as illustrated to the learned decoder 214 illustrated in FIG. 5.

For example, as illustrated in FIG. 6, it is assumed a case where the action result data used to generate the similarity map M02 includes the weight information or the active weight information regarding stocks 1 to n held by a certain fund in a certain period. In this case, the action reproduction data may also include the weight information or the active weight information regarding stocks 1 to n for each period.

Furthermore, for example, as illustrated in FIG. 7, it is assumed a case where the action result data used to generate the similarity map M02 includes information regarding the ratio for each of industry types 1 to n regarding the stocks owned by the fund in a certain period. In this case, the action reproduction data may also include the weight information or the active weight information regarding the industry types 1 to n for each period.

Note that coordinate data used for generating the action reproduction data may be given by the analyst using an external file or the like. Alternatively, the analysis unit 210 may convert a point or a line drawn on the similarity map M02 by the analyst into coordinate data, and use the coordinate data for generation of the action reproduction data.

Furthermore, the analysis unit 210 may extract a region where the density of plots is low (for example, a blank region) on the generated similarity map M02, and automatically generate coordinate data indicating a position of a plot in the region.

In this case, the analysis unit 210 may generate coordinate data so that a plot is generated at a position as far as possible from the existing plot. In addition, in a case where the action reproduction data in time series is generated, coordinate data related to each plot may be generated so as to form a smooth line without an abrupt change.

As described above, with the analysis unit 210 according to the present embodiment, it is possible to simply and accurately reproduce data regarding asset management that can be executed by a new fund having characteristics different from those of an existing fund.

In addition, it is also possible to clarify characteristics such as weight distribution, factor exposure, and sector exposure, and evaluate investment feasibility such as liquidity and investment cost by subjecting the obtained pulse reproduction data to various analyses.

Note that the action result data and the results of various types of analysis based on the action result data can be widely used for search of new funds, development of R & D management with own funds, and the like.

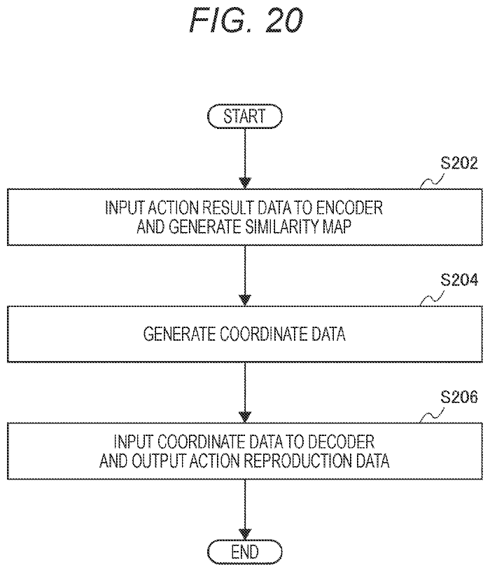

Here, a flow of processing related to generation of the action reproduction data will be described in more detail. FIG. 20 is a flowchart illustrating an example of a flow of the action reproduction data generation according to the present embodiment.

In a case of the example illustrated in FIG. 20, the analysis unit 210 first inputs the action result data to the learned encoder 212 and generates the similarity map (S202).

The similarity map generation in step S202 may be similar to the processing in the first embodiment, and thus detailed description thereof is omitted.

Next, the analysis unit 210 generates coordinate data (S204).

For example, the analysis unit 210 may generate coordinate data on the basis of a point or a line drawn on the similarity map, or may automatically generate coordinate data on the basis of an extracted blank region.

On the other hand, in a case where the coordinate data is given using an external file or the like, the processing in step S204 may be skipped.

Next, the analysis unit 210 inputs the coordinate data to the learned decoder 214, and outputs the action reproduction data (S206).

As described above, the action reproduction data output in step S206 may have the same data structure as the action result data used for generating the similarity map in step S202.

The flow of generating the action reproduction data according to the present embodiment has been described above with an example.

Most of searches for new management methods so far have been mainly for a survey of portfolios similar to existing management methods and an analysis of portfolios brought from the outside.

For this reason, analysis by a person in charge of developing a new management method tends to be biased to an attitude of waiting for information from the outside, and a portfolio obtained as external information is not necessarily a portfolio desired by the own company. Thus, development of a new management method tends to depend on very personal and contingent elements.

On the other hand, with the above-described analysis method according to the present embodiment, the person in charge can voluntarily search for portfolios and management companies that have desirable characteristics according to his/her situation. For this reason, by using the analysis method according to the present embodiment, it is expected that there are effects to achieve reduction of personal natures and contingency in the development process of the new management method, and achieve improvement of productivity and efficiency of the development process.

<<2.2. Representation of Action Reproduction Data Using Existing Action Result Data>>

Next, a representation of the action reproduction data using existing action result data according to the present embodiment will be described.

In the above description, the case where the analysis unit 210 generates the action reproduction data by inputting the coordinate data to the learned decoder 214 has been described. With this configuration, for example, it is possible to easily obtain data reproducing asset management that can be executed by a fictitious new fund having characteristics different from those of an existing fund, and it is possible to use the data for employment of a new fund, or the like.

On the other hand, in the management portfolio, each management entity (asset management company or the like) often sets a unique management upper limit from a viewpoint of liquidity of an investment stock, investment efficiency, and the like. Since the asset owner side such as the fund cannot make additional investment exceeding this management upper limit, the management inevitably has an upper limit constraint.

On the other hand, if it is possible to duplicate a specific fund having a small management upper limit by using a plurality of funds having a large management upper limit, it is possible to relax the constraint on the management upper limit.

In view of the above, the analysis unit 210 according to the present embodiment may represent the action reproduction data corresponding to arbitrary coordinate data by using the action result data of the plurality of task executors.

As an example, the analysis unit 210 according to the present embodiment may represent the action reproduction data corresponding to the action result data of a selected existing task executor by using the action result data of a plurality of other task executors different from the predetermined task executors.

In addition, the analysis unit 210 according to the present embodiment may output information regarding a combination ratio of the action result data of the plurality of task executors used to represent the action reproduction data.

With this configuration, asset management by any existing fund can be reproduced by a combination of asset management by a plurality of other existing funds, and the constraint of the management upper limit can be greatly relaxed.

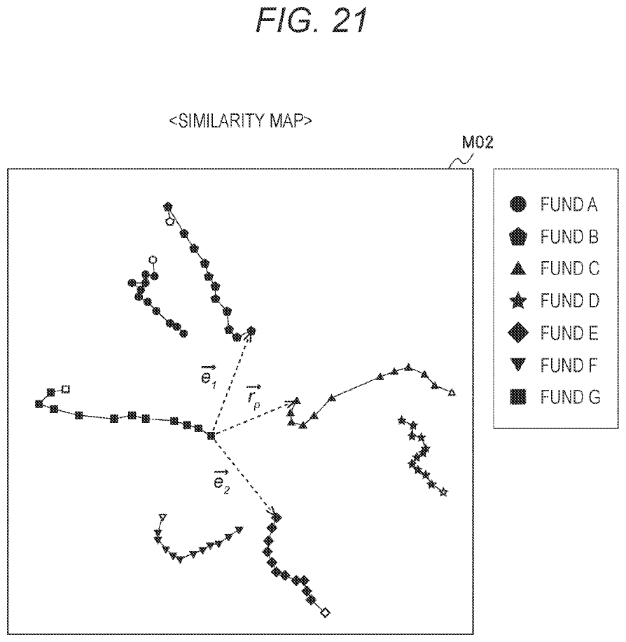

FIG. 21 is a diagram for describing a representation of the action reproduction data using the existing action result data according to the present embodiment.

Note that FIG. 21 illustrates an example of a case where the action reproduction data obtained by reproducing asset management by the existing fund C is represented using the action result data of the existing funds B, E, and G.

In a case where the action reproduction data reproducing the asset management by the predetermined existing fund is to be generated, the action result data of the other three existing funds is used.

At this time, the choice of the action result data of another existing fund to be used may be arbitrary in principle, but it is predicted that one having a longer length of the trajectory formed by the plot based on the action result data, a longer distance between the centers of gravity of the trajectories, and a closer angle of a line segment connecting the centers of gravity to a right angle has higher reproduction accuracy.

The analysis unit according to the present embodiment may calculate the combination ratio on the basis of the positional relationship between plots based on the action result data of each of the plurality of task executors in the similarity map.

More specifically, the analysis unit 210 may generate a linear combination vector representing designated coordinate data by using two position vectors obtained from three plots based on each piece of the action result data of three different task executors, and calculate the combination ratio on the basis of the linear combination vector.

For example, in a case of the example illustrated in FIG. 21, the analysis unit 210 calculates a combination ratio on the basis of the positional relationship between plots based on the action result data of each of the fund B, the fund E, and the fund G in the similarity map M02.

Here, the coordinates of each plot are defined as in the following Expression (1). In this case, a position vector 1 (originating in the plot of the fund G) formed by the plot of the fund G and the plot of the fund B in a certain period can be expressed as the following Expression (2). Similarly, a position vector 2 (originating in the plot of the fund G) formed by the plot of the fund G and the plot of the fund E in a certain period can be expressed as the following Expression (3).

$$[ Expression 1 ]$$

$$\vec{{r}_{i}} = ( {x}_{i} , {y}_{i} ) \qquad ( 1 )$$

$$\vec{{e}_{1}} = \frac{\vec{{r}_{1}} - \vec{{r}_{3}}}{\vert \vec{{r}_{1}} - \vec{{r}_{3}} \vert} = \frac{( {x}_{1} - {x}_{3} , {y}_{1} - {y}_{3} )}{\sqrt{{( {x}_{1} - {x}_{3} )}^{2} + {( {y}_{1} - {y}_{3} )}^{2}}} = ( {e}_{1 x} , {e}_{1 y} ) \qquad ( 2 )$$

$$\vec{{e}_{2}} = \frac{\vec{{r}_{2}} - \vec{{r}_{3}}}{\vert \vec{{r}_{2}} - \vec{{r}_{3}} \vert} = \frac{( {x}_{2} - {x}_{3} , {y}_{2} - {y}_{3} )}{\sqrt{{( {x}_{2} - {x}_{3} )}^{2} + {( {y}_{2} - {y}_{3} )}^{2}}} = ( {e}_{2 x} , {e}_{2 y} ) \qquad ( 3 )$$

The analysis unit 210 according to the present embodiment generates the linear combination vector corresponding to a plot P of the fund C to be reproduced, using the position vector 1 and the position vector 2 described above. At this time, the linear combination vector can be calculated as in the following expression (4).

$$[ Expression 2 ]$$

$$\vec{{r}_{p}} = ( {x}_{p} , {y}_{p} ) = \vec{{r}_{3}} + {α}_{1} \vec{{e}_{1}} + {α}_{2} \vec{{e}_{2}} \qquad ( 4 )$$

$$( \begin{matrix}{e}_{1 x} & {e}_{2 x} \\ {e}_{2 x} & {e}_{2 y}\end{matrix} ) ( \begin{matrix}{α}_{1} \\ {α}_{2}\end{matrix} ) = ( \begin{matrix}{x}_{p} - {x}_{3} \\ {y}_{p} - {y}_{3}\end{matrix} ) ↔ ( \begin{matrix}{α}_{1} \\ {α}_{2}\end{matrix} ) = ( \begin{matrix}{e}_{1 x} & {e}_{2 x} \\ {e}_{2 x} & {e}_{2 y}\end{matrix} ) ( \begin{matrix}{x}_{p} - {x}_{3} \\ {y}_{p} - {y}_{3}\end{matrix} )$$

Next, as illustrated in the following Expression (5), the analysis unit 210 according to the present embodiment uses a coefficient of linear combination (α₁, α₂) to calculate back the combination ratio of the action result data corresponding to each plot of the fund B, the fund E, and the fund G. At this time, each plot of the fund B, the fund E, and the fund G can be expressed by the following Expressions (6) to (8).

$$[ Expression 3 ]$$

$$\vec{{r}_{3}} + {α}_{1} \vec{{e}_{1}} + {α}_{2} \vec{{e}_{2}} = \vec{{r}_{3}} + {α}_{1} \frac{\vec{{r}_{1}} - \vec{{r}_{3}}}{\vert \vec{{r}_{1}} - \vec{{r}_{3}} \vert} + {α}_{2} \frac{\vec{{r}_{2}} - \vec{{r}_{3}}}{\vert \vec{{r}_{2}} - \vec{{r}_{3}} \vert} = \frac{{α}_{1}}{\vert \vec{{r}_{1}} - \vec{{r}_{3}} \vert} \vec{{r}_{1}} + \frac{{α}_{2}}{\vert \vec{{r}_{2}} - \vec{{r}_{3}} \vert} \vec{{r}_{2}} + ( 1 - \frac{{α}_{1}}{\vert \vec{{r}_{1}} - \vec{{r}_{3}} \vert} - \frac{{α}_{2}}{\vert \vec{{r}_{2}} - \vec{{r}_{3}} \vert} ) \vec{{r}_{3}} \qquad ( 5 )$$

$$\frac{{α}_{1}}{\vert \vec{{r}_{1}} - \vec{{r}_{3}} \vert} \qquad ( 6 )$$

$$\frac{{α}_{2}}{\vert \vec{{r}_{2}} - \vec{{r}_{3}} \vert} \qquad ( 7 )$$

$$( 1 - \frac{{α}_{1}}{\vert \vec{{r}_{1}} - \vec{{r}_{3}} \vert} - \frac{{α}_{2}}{\vert \vec{{r}_{2}} - \vec{{r}_{3}} \vert} ) \qquad ( 8 )$$

As described above, with the analysis unit 210 according to the present embodiment, it is possible to represent the action reproduction data corresponding to arbitrary coordinate data by using the action result data of the plurality of task executors.

Note that, in the above description, a case where asset management by a certain existing fund is reproduced by the action result data of the plurality of other existing funds has been exemplified, but the analysis unit 210 according to the present embodiment can represent a task corresponding to arbitrary coordinates by the existing action result data regardless of whether or not the task is existing.

For example, as described above, the analysis unit 210 may represent a plot automatically generated in the blank region using an existing plot. With this configuration, it is also possible to achieve asset management having characteristics different from those of existing funds by combining the existing funds.

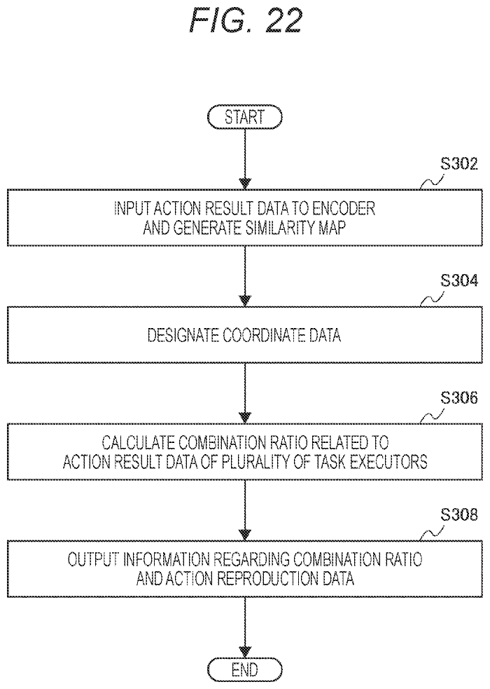

Next, a flow of action reproduction data output using the existing action result data according to the present embodiment will be described in detail with reference to FIG. 22.

In a case of the example illustrated in FIG. 22, the analysis unit 210 first inputs the action result data to the learned encoder 212 and generates the similarity map (S302).

The similarity map generation in step S302 may be similar to the processing in the first embodiment, and thus detailed description thereof is omitted.

Next, coordinate data of a plot corresponding to the reproduced action reproduction data is designated (S304).

For example, in a case where the action reproduction data related to the existing fund is generated, an arbitrary existing fund may be designated using the user interface. Note that the coordinate data designated in step S304 is not limited to a plot related to the existing fund as described above.

Next, the analysis unit 210 calculates a combination ratio related to the action result data of the plurality of task executors on the basis of the coordinate data designated in step S304 (S306).

Next, the analysis unit 210 outputs information regarding the combination ratio calculated in step S306 and the action reproduction data generated on the basis of the combination ratio (S308).

### 3. Hardware Configuration Example

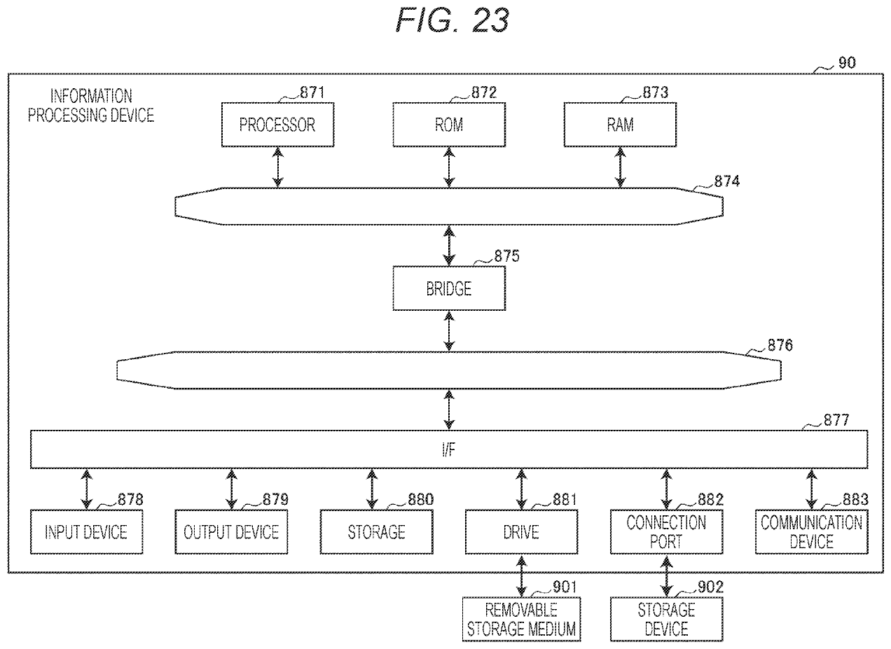

Next, a hardware configuration example common to the learning device 10 and the analysis device 20 according to one embodiment of the present disclosure will be described. FIG. 23 is a block diagram illustrating a hardware configuration example of the information processing device 90 according to one embodiment of the present disclosure. The information processing device 90 may be a device having a hardware configuration equivalent to that of each of the devices described above.

As illustrated in FIG. 23, the information processing device 90 includes, for example, a processor 871, a ROM 872, a RAM 873, a host bus 874, a bridge 875, an external bus 876, an interface 877, an input device 878, an output device 879, a storage 880, a drive 881, a connection port 882, and a communication device 883. Note that the hardware configuration illustrated here is an example, and some of the components may be omitted. Furthermore, components other than the components illustrated here may be further included.

(Processor 871)

The processor 871 functions as, for example, an arithmetic processing device or a control device, and controls the overall operation of each component or a part thereof on the basis of various programs recorded in the ROM 872, the RAM 873, the storage 880, or a removable storage medium 901.

(ROM 872 and RAM 873)

The ROM 872 is a unit that stores a program read by the processor 871, data used for calculation, and the like. The RAM 873 temporarily or permanently stores, for example, a program read by the processor 871, various parameters that appropriately change when the program is executed, and the like.

(Host Bus 874, Bridge 875, External Bus 876, and Interface 877)

The processor 871, the ROM 872, and the RAM 873 are mutually connected via, for example, the host bus 874 capable of high-speed data transmission. On the other hand, the host bus 874 is connected to the external bus 876 having a relatively low data transmission speed via the bridge 875, for example. Furthermore, the external bus 876 is connected to various components via the interface 877.

(Input Device 878)

As the input device 878, for example, a mouse, a keyboard, a touch panel, a button, a switch, a lever, and the like are used. Moreover, as the input device 878, a remote controller (hereinafter, remote controller) capable of transmitting a control signal using infrared rays or other radio waves may be used. Furthermore, the input device 878 includes a voice input device such as a microphone.

(Output Device 879)

The output device 879 is a device capable of visually or audibly notifying the user of acquired information, such as a display device such as a cathode ray tube (CRT), an LCD, or an organic EL, an audio output device such as a speaker or a headphone, a printer, a mobile phone, or a facsimile, for example. Furthermore, the output device 879 according to the present disclosure includes various vibration devices capable of outputting tactile stimulation.

(Storage 880)

The storage 880 is a device for storing various data. As the storage 880, for example, a magnetic storage device such as a hard disk drive (HDD), a semiconductor storage device, an optical storage device, a magneto-optical storage device, or the like is used.

(Drive 881)

The drive 881 is, for example, a device that reads information recorded on the removable storage medium 901 such as a magnetic disk, an optical disk, a magneto-optical disk, or a semiconductor memory, or writes information to the removable storage medium 901.

(Removable Storage Medium 901)

The removable storage medium 901 is, for example, a DVD medium, a Blu-ray (registered trademark) medium, an HD DVD medium, various semiconductor storage media, or the like. Of course, the removable storage medium 901 may be, for example, an IC card on which a non-contact IC chip is mounted, an electronic device, or the like.

(Connection Port 882)

The connection port 882 is a port for connecting an external connection device 902 such as a universal serial bus (USB) port, an IEEE1394 port, a small computer system interface (SCSI), an RS-232C port, or an optical audio terminal, for example.

(External Connection Device 902)

The external connection device 902 is, for example, a printer, a portable music player, a digital camera, a digital video camera, an IC recorder, or the like.

(Communication Device 883)

The communication device 883 is a communication device for connecting to a network, for example, a wired or wireless LAN, Bluetooth (registered trademark), or a communication card for Wireless USB (WUSB), a router for optical communication, a router for Asymmetric Digital Subscriber Line (ADSL), or a modem for various communications, or the like.

### 4. Summary

As described above, the analysis device 20 according to the second embodiment of the present disclosure includes the analysis unit 210 that generates the similarity map representing a similarity between actions by each of the plurality of task executors on the two-dimensional plane on the basis of the action result data indicating a result of action regarding a predetermined task.

Furthermore, the analysis unit 210 according to the second embodiment of the present disclosure outputs action reproduction data having the same data structure as the action result data on the basis of coordinate data indicating a position of a plot in the similarity map.

With the above configuration, an executed task or a task that can be executed by a third party can be reproduced with high accuracy.

The preferred embodiments of the present disclosure have been described above in detail with reference to the accompanying drawings, but the technical scope of the present disclosure is not limited to such examples. It is apparent that a person having ordinary knowledge in the technical field of the present disclosure can devise various change examples or modification examples within the scope of the technical idea described in the claims, and it will be naturally understood that they also belong to the technical scope of the present disclosure.

Furthermore, each step related to the processing described in the present specification is not necessarily processed in time series in the order described in the flowchart or the sequence diagram. For example, each step related to the processing of each device may be processed in an order different from the described order or may be processed in parallel.

Further, the series of processes performed by each device described in the present description may be achieved using any of software, hardware, and a combination of software and hardware. The program constituting the software is provided inside or outside each device, for example, and is stored in advance in a non-transitory computer readable medium readable by a computer. Then, for example, each program is read into the RAM when the computer executes the program, and is executed by a processor. The storage medium described above is, for example, a magnetic disk, an optical disk, a magneto-optical disk, a flash memory, or the like. Furthermore, the computer program described above may be distributed via, for example, a network without using a storage medium.

Furthermore, the effects described in the present description are merely illustrative or exemplary and are not limited. That is, the technology according to the present disclosure can exhibit other effects that are apparent to those skilled in the art from the present description in addition to or instead of the effects described above.

Note that configurations as follows also belong to the technical scope of the present disclosure.

(1)

An information processing device including
an analysis unit that generates a similarity map representing a similarity between actions by each of a plurality of task executors on a two-dimensional plane on the basis of action result data indicating a result of the action regarding a predetermined task, in which
the analysis unit outputs action reproduction data having a same data structure as the action result data on the basis of coordinate data representing a position of a plot in the similarity map.

(2)

The information processing device according to (1) above, in which
the analysis unit represents a change in the action in time series by each of a plurality of the task executors in the similarity map, and
outputs the action reproduction data representing a change in time series on the basis of a plurality of pieces of the coordinate data.

(3)

The information processing device according to (1) or (2) above, in which
the analysis unit extracts a region where density of plots is low on the generated similarity map, and outputs the action reproduction data on the basis of the coordinate data indicating a position of a plot in the region.

(4)

The information processing device according to (1) or (2) above, in which
the analysis unit represents the action reproduction data corresponding to the coordinate data by using the action result data of the plurality of task executors.

(5)

The information processing device according to (4) above, in which
the analysis unit represents the action reproduction data corresponding to the action result data of a selected predetermined task executor by using the action result data of a plurality of other task executors different from the predetermined task executor.

(6)

The information processing device according to (4) or (5) above, in which
the analysis unit outputs information regarding a combination ratio of the action result data of the plurality of task executors to be used to represent the action reproduction data.

(7)

The information processing device according to (6) above, in which
the analysis unit calculates the combination ratio on the basis of the positional relationship between plots based on the action result data of each of the plurality of task executors in the similarity map.

(8)

The information processing device according to (7) above, in which
the analysis unit generates a linear combination vector representing designated coordinate data by using two position vectors obtained from three plots based on each piece of the action result data of three different task executors, and calculate the combination ratio on the basis of the linear combination vector.

(9)

The information processing device according to (1) above, in which
the analysis unit generates the similarity map by inputting the action result data to a learned encoder.

(10)

The information processing device according to (9) above, in which
the analysis unit inputs the coordinate data to the learned decoder, and outputs the action reproduction data.

(11)

The information processing device according to (10) above, in which
the encoder and the decoder are generated by learning related to a variational auto-encoder.

(12)

The information processing device according to (1) above, in which
the predetermined task includes asset management.

(13)

The information processing device according to (12) above, in which
the action includes a trading transaction of a financial product.

(14)

The information processing device according to (13) above, in which
the type of the action includes owning of the financial product of a predetermined stock.

(15)

The information processing device according to (13) above, in which
the type of the action includes owning of the financial product corresponding to a predetermined industry type.

(16)

The information processing device according to (13) above, in which
the type of the action includes owning of the financial product corresponding to a predetermined factor.

(17)

The information processing device according to (13) above, in which
the action result data and the action reproduction data include weight information related to a financial product.

(18)

The information processing device according to (1) above, further including
a display unit that displays the similarity map.

(19)

An information processing method including:
generating, by a processor, a similarity map representing a similarity between actions by each of a plurality of task executors on a two-dimensional plane on the basis of action result data indicating a result of the action regarding a predetermined task; and
outputting action reproduction data having a same data structure as the action result data on the basis of coordinate data representing a position of a plot in the similarity map.

(20)

A program for causing a computer to function as an information processing device including
an analysis unit that generates a similarity map representing a similarity between actions by each of a plurality of task executors on a two-dimensional plane on the basis of action result data indicating a result of the action regarding a predetermined task, in which
the analysis unit outputs action reproduction data having a same data structure as the action result data on the basis of coordinate data representing a position of a plot in the similarity map.

### REFERENCE SIGNS LIST

10 Learning device
110 Learning unit
120 Storage unit
20 Analysis device
210 Analysis unit
212 Encoder
214 Decoder
216 SHAP
218 Projector
220 Storage unit
230 Display unit
240 Operation unit

1. An information processing device comprising
an analysis unit that analyzes a tendency of a preference related to an action on a basis of action result data indicating a result of the action regarding a predetermined task, wherein
the analysis unit generates a similarity map representing a similarity between the actions by each of a plurality of task executors including an analysis target person on a two-dimensional plane on a basis of the action result data, and represents strength of a preference related to a type of the action selected in a heat map form in the similarity map.

2. The information processing device according to claim 1, wherein
the analysis unit represents a change in the action in time series by each of a plurality of the task executors in the similarity map.

3. The information processing device according to claim 1, wherein
the analysis unit generates the similarity map representing a similarity between at least the action by the analysis target person and the action by a designated comparison target person on a two-dimensional plane, and represents strength of a preference of the analysis target person and strength of a preference of the comparison target person according to the type of the action selected in the heat map form in the similarity map.

4. The information processing device according to claim 3, wherein
the analysis unit selects a type of the action having a large difference in strength of preferences between the analysis target person and the comparison target person, and represents the strength of the preference related to the type of the action selected in the heat map form in the similarity map.

5. The information processing device according to claim 3, wherein
the analysis unit presents a plurality of types of the action having a large difference in strength of preferences between the analysis target person and the comparison target person to a user, and represents the strength of the preference related to the type of the action selected by the user in the heat map form in the similarity map.

6. The information processing device according to claim 4, wherein
the analysis unit selects a type of the action having a large difference in strength of preferences between the analysis target person and the comparison target person on a basis of a degree of contribution of each element included in the action result data to the generation of the similarity map.

7. The information processing device according to claim 6, wherein
the analysis unit presents the degree of contribution to a user.

8. The information processing device according to claim 7, wherein
the analysis unit represents strength of a preference related to a type of the action corresponding to an element included in the action result data selected by the user on a basis of the degree of contribution to be presented in the heat map form in the similarity map.

9. The information processing device according to claim 1, wherein
the analysis unit generates the similarity map by inputting the action result data to a learned encoder.

10. The information processing device according to claim 9, wherein
the analysis unit represents the strength of the preference related to the type of the action in the heat map form in the similarity map on a basis of output data obtained by inputting a latent variable at an arbitrary point on the similarity map to a learned decoder.

11. The information processing device according to claim 10, wherein
the encoder and the decoder are generated by learning related to a variational auto-encoder.

12. The information processing device according to claim 1, wherein
the predetermined task includes asset management.

13. The information processing device according to claim 12, wherein
the action includes a trading transaction of a financial product.

14. The information processing device according to claim 13, wherein
the type of the action includes owning of the financial product of a predetermined stock.

15. The information processing device according to claim 13, wherein
the type of the action includes owning of the financial product corresponding to a predetermined industry type.

16. The information processing device according to claim 13, wherein
the type of the action includes owning of the financial product corresponding to a predetermined factor.

17. The information processing device according to claim 13, wherein
the action result data includes weight information related to a financial product.

18. The information processing device according to claim 1, further comprising
a display unit that displays the similarity map.

19. An information processing method comprising:
analyzing, by a processor, a tendency of a preference related to an action on a basis of action result data indicating a result of the action regarding a predetermined task, wherein
the analyzing further includes generating a similarity map representing a similarity between the actions by each of a plurality of task executors including an analysis target person on a two-dimensional plane on a basis of the action result data, and representing strength of a preference related to a type of the action selected in a heat map form in the similarity map.

20. A program for causing a computer to function as an information processing device including
an analysis unit that analyzes a tendency of a preference related to an action on a basis of action result data indicating a result of the action regarding a predetermined task, wherein
the analysis unit generates a similarity map representing a similarity between the actions by each of a plurality of task executors including an analysis target person on a two-dimensional plane on a basis of the action result data, and represents strength of a preference related to a type of the action selected in a heat map form in the similarity map.
